(19) United States
(12) Patent Application Publication
(10) Pub. No.: US 2025/0196174 A1
(43) Pub. Date: Jun. 19, 2025

(54) DOUBLE-SIDED DISPOSABLE COATING DEVICE

(71) Applicants: Guangdong XINYONGTAI New Material Tech Co., Ltd., Kaiping City (CN); Foshan Nanhai XINYONGTAI Adhesive Products Co. LTD, Foshan City (CN)

(72) Inventors: Daman PAN, Kaiping City (CN); Jinzuo ZHU, Kaiping City (CN); Weichao ZHU, Kaiping City (CN); Jinji ZHU, Kaiping City (CN); Shiyong FU, Kaiping City (CN)

(21) Appl. No.: 18/601,212

(22) Filed: Mar. 11, 2024

(30) Foreign Application Priority Data
Dec. 19, 2023 (CN) 2023117534895

(51) Int. Cl. B05C 1/08

(52) U.S. Cl. CPC B05C 1/0808; B05C 1/0834

(57) ABSTRACT

A double-sided disposable coating device is disclosed, relating to the technical field of coating equipment. The double-sided disposable coating device includes an unwinding device, a double-sided coating device, a suspension oven, a post-treatment device, and a winding device. A substrate roll is arranged on the unwinding device and the unwinding device is configured to release a substrate. The double-sided coating device is configured to perform double-sided coating on the substrate released from the unwinding device. The suspension oven is configured to perform double-sided drying on a coated substrate. The post-treatment device is configured to perform post-treatment on a dried material. The winding device is configured to wind a finished product after post-treatment. The double-sided disposable coating device is energy-saving, low in consumption, and high in efficiency.

### CROSS-REFERENCE TO RELATED APPLICATION

This patent application claims the benefit and priority of Chinese Patent Application No. 2023117534895 filed with the China National Intellectual Property Administration on Dec. 19, 2023, the disclosure of which is incorporated by reference herein in its entirety as part of the present application.

### TECHNICAL FIELD

The present disclosure relates to the technical field of coating equipment, and in particular to a double-sided disposable coating device.

### BACKGROUND

Double-sided coating has always been one of the production forms that pursue high efficiency in coating. In the past, during double-sided coating, through a series superposition process, one side of a substrate is coated, crosslinked, cured, and dried, then another side is coated, and sent to another oven for crosslinking and curing after coating. The device for double-sided coating is shown in FIG. 8 of the specification. Although the two procedures for the product can be completed at one time, the essence is also a single-sided coating method due to the adoption of the series superposition process, and the only advantages is that labor cost is reduced due to the adoption of the superposition process. However, there are many shortcomings in this process, which are mainly reflected in: (1) the passing path is circuitous, leading to a long passing path, which may cause significant waste when the material is broken during the production process; (2) the passing of the material is difficult and lasts for a long time; (3) because this process is the superposition of two procedures, there are two coating devices, the number of corresponding personnel is not significantly decreased compared to two machines with single-layer process, and the number of corresponding personnel can only be configured at 1.5 times the single-layer process; (4) serious water loss of the material is caused as the material is dried twice, which is easy to cause material deformation and lead to poor appearance, and the material cannot be returned to its original state; (5) due to the long passing path, the material needs to pass through many supporting guide rollers, so the resistance that needs to be overcome is increased, resulting in a large tension driven by the material, which is easy to cause material deformation, in particular, thin plastic materials or low-weight materials are easy to deform or break; and (6) because superposed double-layer drying tunnels are used in the oven, the oven is large in thickness, resulting in a large equipment space, and the oven cannot be accommodated in ordinary factories. Therefore, based on the above shortcomings, the application field and scope of the series superposition process are significantly limited.

### SUMMARY

The purpose of the present disclosure is to provide a double-sided disposable coating device, so as to solve the problems in the prior art. The double-sided disposable coating device has the advantages of energy conversation, consumption reduction, and high efficiency.

To achieve the purpose above, the present disclosure provides the following technical solution:

A double-sided disposable coating device provided by the present disclosure includes:
an unwinding device, a substrate roll is arranged on the unwinding device, and the unwinding device is configured to release a substrate;
a double-sided coating device, the double-sided coating device is configured to perform double-sided coating on the substrate released from the unwinding device;
a suspension oven, the suspension oven is configured to perform double-sided drying on a coated substrate;
a post-treatment device, the post-treatment device is configured to perform post-treatment on a dried material; and
a winding device, the winding device is configured to wind a finished product after post-treatment.

Preferably, a coating used in the double-sided coating device is a solvent-free thermosetting organosilicon release agent with a viscosity of 200-500 CPS.

Preferably, the double-sided coating device includes a coating channel and coating units, the coating channel is configured for the substrate to pass through, the coating units are arranged on both sides of the coating channel, and each of the coating units comprises a bath roller, metering rollers, a transfer roller, and a coating roller. A bath is formed by the bath roller, the metering rollers, and port baffles at ports of the bath roller and the metering rollers. The coating roller, the transfer roller, the metering rollers and the bath are arranged from the coating channel in a direction away from the coating channel in sequence. Rotational speeds of the metering rollers, the transfer roller and the coating roller are adjustable, and a coating amount of the coating is adjusted by controlling a speed difference among the metering rollers, the transfer roller, and the coating roller.

Preferably, rollers in the coating units are each in a form of rigid-flexible combination, and any two adjacent rollers of the rollers are a rigid roller and a flexible roller, respectively. A surface of the rigid roller is encapsulated, with a surface roughness of less than 0.05, a run-out accuracy of Grade 5, and a dynamic balance of G2.5/400 rpm. The flexible roller is obtained by wrapping a layer of urethane adhesive outside the rigid roller, with a hardness of 70-80 HA.

Preferably, the transfer roller is a ceramic roller with an alumina surface layer, with a surface roughness of less than 0.05, a run-out accuracy of Grade 5, and a dynamic balance of G2.5/400 rpm.

Preferably, speeds of the rollers in the coating units are controlled in a vector closed-loop control mode, and in cooperation with an encoder with a resolution greater than 2000 P/R to achieve frequency conversion speed regulation with high-precision and high-rigidity.

Preferably, the double-sided disposable coating device further includes a corona device. The corona device is configured to treat a surface of the substrate and then the substrate is conveyed to the double-sided coating device for coating.

Preferably, the suspension oven is configured to achieve suspension of the substrate by blowing air through air nozzles, each of the air nozzles comprises an air inlet and an air outlet, and a buffer plate is arranged between the air inlet and the air outlet.

Preferably, the post-treatment device comprises an air-cooling device, a cooling and ironing device, and a steam rewetting device which are arranged in sequence. The air-cooling device is configured to cool a thermally cured material, the cooling and ironing device is configured to cool and iron a cooled material, and the steam rewetting device is configured to perform steam rewetting on an ironed and cooled material by means of an electrostatic field.

Preferably, a steam rewetting amount of the steam rewetting device is controlled by a proportional valve, and the steam rewetting amount is controlled through a combination of a production speed of the material and a rewetting amount.

Compared with the prior art, the present disclosure achieves the following technical effects.

The double-sided disposable coating device provided by the present disclosure can apply disposable coating on both sides of the substrate, and a suspension drying process of one-way disposable double-sided simultaneous crosslinking reaction is achieved by a non-contact suspension oven, thereby completing roll-to-roll continuous production of double-sided release paper. The oven uses an air-floating suspension mode without guide rollers, which is different from the current process using double coating heads and double-way S-shaped double-layer laminated oven, an one-way drying tunnel capable of simultaneously spraying hot air of double sides to the surface of the material is achieved, so that the length of the passing path is significantly shortened, the heat energy utilization of the oven is significantly improved, and the defects such as scratches on the surface of the product caused by the guide rollers are further reduced, and thus an efficient coating mode with maximum energy conservation and consumption reduction is achieved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those skilled in the art may still derive other drawings from these accompanying drawings without creative efforts.

FIG. 1 is a structural schematic diagram of a double-sided disposable coating device according to an embodiment of the present disclosure;

FIG. 2 is a structural schematic diagram of an unwinding device, a double-sided coating device, and a suspension oven in FIG. 1;

FIG. 3 is a structural schematic diagram of a double-sided coating device in FIG. 1;

FIG. 4 is a structural schematic diagram of a suspension oven;

FIG. 5 is a structural schematic diagram of an upper oven and a lower oven;

FIG. 6 is a structural schematic diagram of an air nozzle;

FIG. 7 is a structural schematic diagram of a gap adjusting device; and

FIG. 8 is a structural schematic diagram of a double-sided coating device in the related art.

Reference signs: 1 unwinding device; 101 unwinding tension swing roller; 102 automatic cutter; 103 substrate roll; 104 unwinding shaft; 2 corona device; 3 double-sided coating device; 4 suspension oven; 5 tension detection device at oven section; 6 air-cooling device; 7 edge tracking swing roller; 8 cooling and ironing device; 9 tension detection assembly before rewetting; 10 steam rewetting device; 11 secondary cooling and ironing device; 12 tension detection assembly before secondary rewetting; 13 secondary steam rewetting device; 14 ironing device before winding; 15 winding device; 151 winding tension swing roller; 16 master control electric cabinet; 31 coating roller gap adjusting device; 310 bidirectional adjusting hydraulic cylinder; 311 hydraulic cylinder rod; 312 receding oil pipe; 313 extending oil pipe; 314 gap adjusting handle; 315 transmission worm; 316 transmission worm gear; 317 adjusting nut; 318 high precision thread; 319 limiting device; 321 coating roller seat; 322 slider; 323 guide rail; 32 coating roller; 33 transfer roller; 34 second metering roller; 35 first metering roller; 36 bath roller; 37 bath; 38 bath roller gap adjusting device; 39 first metering roller gap adjusting device; 41 air nozzle; 42 lower air inlet chamber; 43 upper air inlet chamber; 44 lower oven; 45 upper oven; 48 circulating fan; 49 burner; 50 centrifugal fan; 401 air inlet duct connecting port; 402 observation window; 403 air inlet duct; 404 air brake; 405 air return duct connecting port; 406 air return duct; 411 air outlet; 412 outer cover; 413 inner cover; 414 mounting base plate; 415 buffer plate; 421 base plate; 431 positioning groove; 432 end clamping plate; 460 filter.

In FIG. 8: 201 unwinding device of traditional device; 203 corona device of traditional device; 205 coating device of traditional device; 207 first channel of drying device of traditional device; 209 cooling device of traditional device; 211 second coating device of traditional device; 213 second channel of drying device of traditional device; 215 second cooling device of traditional device; 217 rewetting device of traditional device; 219 third cooling device of traditional device; 221 winding device of traditional device.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

In order to make the purpose, technical solutions and advantages of the present disclosure more clearly, the present disclosure is further described in detail below with reference to the embodiments.

FIG. 8 is a structural schematic diagram of a double-sided coating device in the related art.

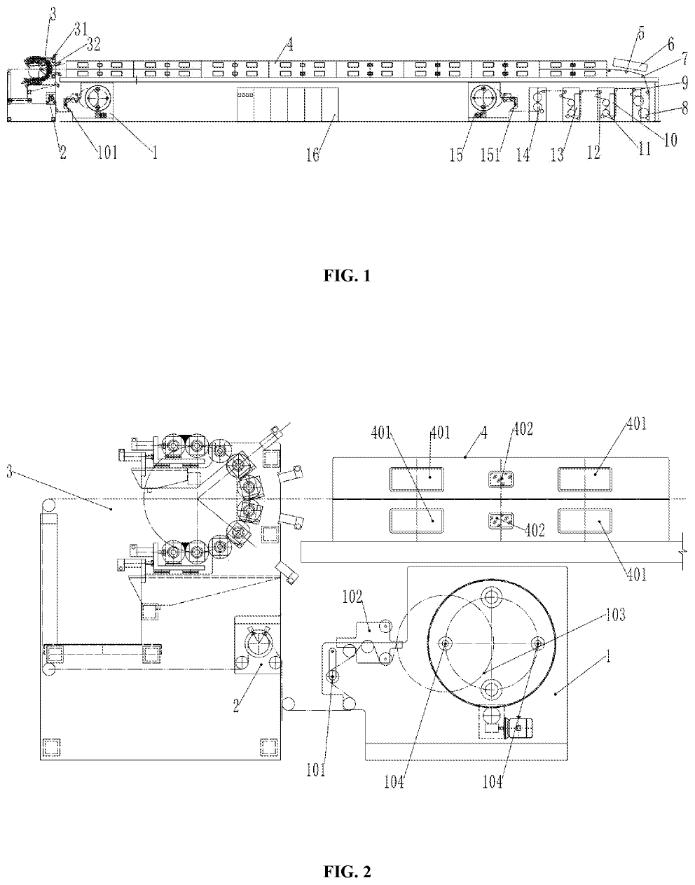

A double-sided disposable coating device is provided by the present disclosure, as shown in FIG. 1 and FIG. 2, the double-sided disposable coating device includes an unwinding device 1, a double-sided coating device 3, a suspension oven 4, a post-treatment device, and a winding device 15. A substrate roll 103 is arranged on the unwinding device 1, and the unwinding device 1 is configured to release a substrate. The double-sided coating device 3 is configured to perform double-sided coating on the substrate released from the unwinding device 1. The suspension oven 4 is configured to perform double-sided drying on the coated substrate. The post-treatment device is configured to perform post-treatment, such as cooling, ironing, and rewetting, on the dried material. The winding device 15 is configured to wind a finished product obtained after post-treatment.

The double-sided disposable coating device provided by the present disclosure can perform disposable coating on both sides of the substrate, and a suspension drying process of one-way disposable double-sided simultaneous crosslinking reaction is achieved by a non-contact suspension oven 4, thereby completing roll-to-roll continuous production of double-sided release paper. The oven uses an air-floating suspension mode without guide rollers, its drag tension is small, so that the deformation of the material is minimal, which is different from the current process using double coating heads and double-way S-shaped double-layer laminated oven, an one-way drying tunnel capable of simultaneously spraying hot air of double sides to the surface of the material is achieved, so that the length of the passing path is significantly shortened, the heat energy utilization of the oven is significantly improved, and the defects such as scratches on the surface of the product caused by the guide rollers are further reduced, and thus efficient coating mode with maximum energy conservation and consumption reduction is achieved.

In a preferred embodiment of the present disclosure, a double-station automatic unwinding device 1 with deviation correction is selected as an unwinding device 1. A double-station automatic winding device 15 is selected as a winding device 15. An automatic cutter 102 and a swing roller device for tension control and regulation are arranged in both the unwinding device 1 and the winding device 15. The swing roller devices are a winding tension swing roller 151 and an unwinding tension swing roller 101 in FIG. 1. In addition, an electric edge tracking swing roller 7, with an edge tracking accuracy of less than or equal to 1 mm (edge/line positioning) is arranged in the unwinding device 1. The substrate is transferred to a movable tool carrier on any of unwinding shafts 104 of the unwinding device 1 through guide rollers arranged on the device, and then is led out to a corona device 2 after passing through the unwinding tension swing roller 101. The corona device 2 is a double-sided corona device with simultaneous discharge from top and bottom, and the power should meet the requirement of treating a PEK (polyetherketone) material with a power of at least 42 dynes and treating a PET (polyethylene terephthalate) material with a power of up to 56 dynes. The device has a speed reaching function, a power adjusting function and a vibration starting function, among which the speed reaching function can be used to adjust speed to be reached to start vibration as needed, and the energy adjusting function can be used to set appropriate power according to different materials, so as to make the surface tension of the material at a suitable coated surface tension and reduce the use of anchoring agents.

In this embodiment, the corona device 2 can make anchorage of the organosilicon better. Before coating, the corona device 2 for treating a double-sided surface of the material is introduced, which makes attachment of the organosilicon on the substrate better, and anchorage of the coating better. Meanwhile, the usage amount of the anchoring agent can be reduced.

In some embodiments, the coating used in the double-sided coating device 3 is a solvent-free thermosetting organosilicon release agent, with a viscosity of 200-500 CPS.

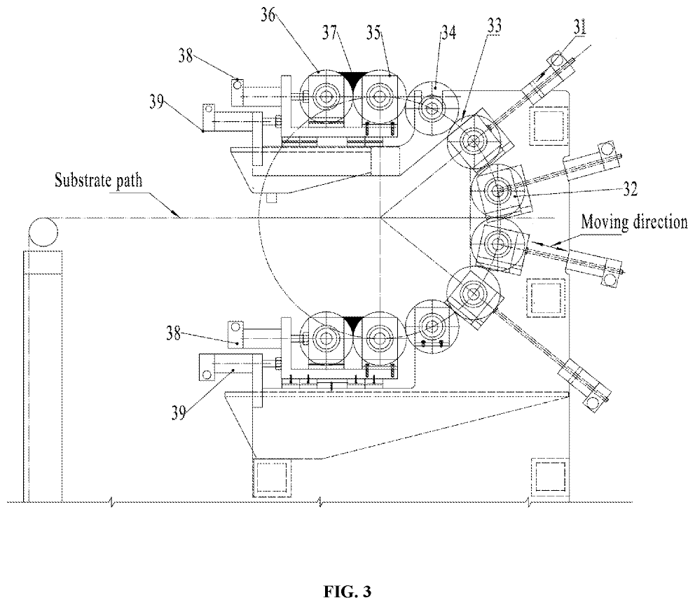

In some embodiments, as shown in FIG. 3, the double-sided coating device 3 includes a coating channel for the substrate to pass through. Coating units are arranged at both sides of the coating channel. The coating unit includes a bath 37, metering rollers, a transfer roller 33, and a coating roller 32. The coating roller 32, the transfer roller 33, the metering rollers and the bath 37 are arranged from the coating channel in a direction away from the coating channel in sequence. The bath 37 is formed by a bath roller 36, the metering rollers, and port baffles. Rotational speeds of the metering rollers, the transfer roller 33 and the coating roller 32 are adjustable, and a coating amount of the coating is adjusted by controlling a speed difference among the metering rollers, the transfer roller, 33 and the coating roller 32. Preferably, the bath roller 36, the metering rollers, the transfer roller 33 and the coating roller 32 are all arranged on a wall board or a rack.

In order to control the coating amount more precisely, two metering rollers are provided, which are respectively a first metering roller 35 and a second metering roller 34. The coating liquid is placed in the bath 37, and then is carried to the substrate after passing through the first metering roller 35, the second metering roller 34, the transfer roller 33, and the coating roller 32. The coating amount can be set by setting the speed percentage of the first metering roller 35 and the second metering roller 34 and the transfer roller 33, and the percentage accurate to 0.1% is sufficient. The two coating units are arranged symmetrically, and thus the coating can be completed on the upper and lower surfaces of the substrate at one time. The coating amount is adjusted by controlling a speed difference between the first metering roller 35 as well as the second metering roller 34 and the transfer roller 33. The greater the speed difference, the less the coating amount is applied to the substrate, and the coating amount can be as low as 0.4 g/m² under the extreme speed difference. Theoretically, the coating amount can be lower, but if the coating amount is lower than 0.4 g/m², the large speed difference may easily cause the friction increase of the rollers, leading to the damage of the rubber of the coating roller 32, so the coating amount is not recommended to be lower than 0.4 g/m². In order to prevent the coating roller 32 from producing heat due to friction caused by speed difference, cooling water is introduced into the center of the coating roller 32, and the cooling water is controlled at a temperature from condensation and a temperature of the roller surface does not exceed 35° C., otherwise, it is easy to cause the pre-crosslinking reaction of silicone oil in the bath 37.

In some embodiments, the bath roller 36, the metering rollers, the transfer roller 33 and the coating roller 32 in the coating unit are arranged on a movable roller seat, the roller seat is arranged on a slider in a slider bearing, a guide rail of the slider is arranged on a wallboard, and the axis of each roller is perpendicular to the wallboard.

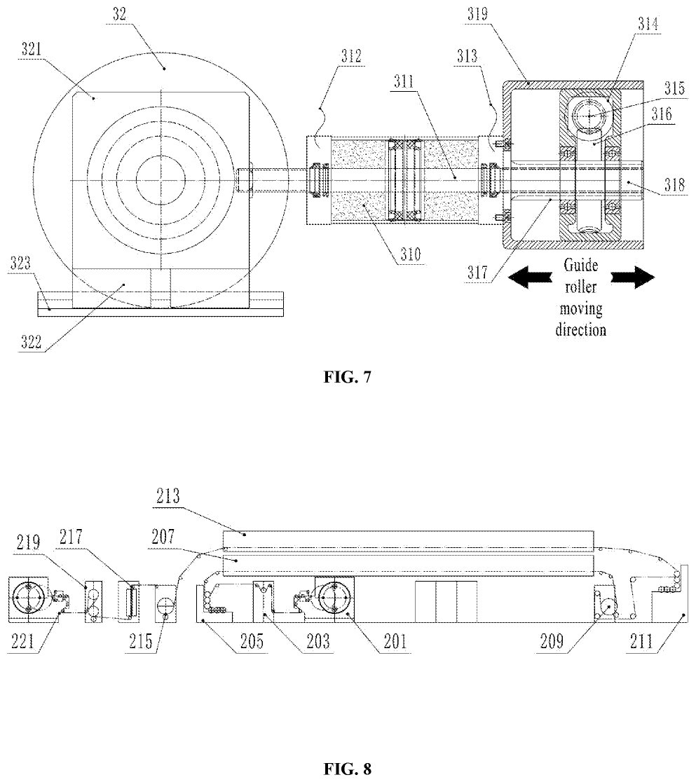

In some embodiments, as shown in FIG. 7, in order to ensure the stability of the coating amount, except for the second metering roller 34, other rollers are all arranged on the movable roller seats, and a gap between the adjacent rollers is adjusted by a gap adjusting device. One roller corresponds to one gap adjusting device, and only one roller (the coating roller) is used for description. One coating roller corresponds to one coating roller gap adjusting device 31, and the coating roller gap adjusting device 31 includes a bidirectional adjusting hydraulic cylinder 310, a gearbox, and a hydraulic cylinder rod 311 of bidirectional adjusting hydraulic cylinder 310 driven by the adjusting nut 317 driven by the gearbox. The coating roller 32 is arranged on a coating roller seat 321. The coating roller seat 321 is slidably arranged on a slider 322 of the slider bearing, and a guide rail 323 of the slider bearing is mounted on the wallboard. One end of the hydraulic cylinder rod 311 of the bidirectional adjusting hydraulic cylinder 310 is mounted on the coating roller seat 321, and the other end of the hydraulic cylinder rod 311 of the bidirectional adjusting hydraulic cylinder 310 is formed with a high-precision thread 318 and is in a threaded connection with the adjusting nut. The adjusting nut is mounted on an adjusting seat of the gearbox, the gearbox is arranged in a limiting device 319, and the limiting device 319 is used to limit rotational degree of freedom of the gearbox, thus making the gearbox only move along an axial direction of the hydraulic cylinder rod 311. The gearbox is consisted of a worm-gear pair, the worm-gear pair includes a transmission worm 315 and a transmission worm gear 316 in a gear ratio of 1:100. A central hole of the transmission worm gear 316 is provided with a spline and is fitted with a spline of the adjusting nut. During use, the coating roller 32 is driven away or into a coating position through the bidirectional adjusting hydraulic cylinder 310, and the gearbox is used to finely adjust the position of the coating roller 32. When the two coating rollers 32 are driven away or into the coating position, the bidirectional adjusting hydraulic cylinder 310 drives the hydraulic cylinder rod 311 to drive the coating roller seat 321 and the coating roller 32 to move. During fine adjustment, through a gap adjusting handle 314 mounted on the transmission worm 315, a force is transmitted to the transmission worm gear 316, the transmission worm gear 316 rotates to drive the adjusting nut 317, thus enabling the hydraulic cylinder rod 311 to drive the coating roller seat 321 and the coating roller 32 to move slightly. The rough adjustment of the coating roller 32 is carried out by a two-position three-way solenoid valve mounted in a hydraulic system of the bidirectional adjusting hydraulic cylinder 310. The action of the two-position three-way solenoid valve is coupled with a control center PLC (programmable logic controller), and provided with a manual/automatic mode. In an automatic state, when the material is broken, the two coating rollers 32 can be automatically controlled to be separated from each other to release a pressing state, and the two coating rollers can be engaged into (can be pressed into) the coating position during operation.

An oil return pipe 312 and an oil inlet pipe 313 for controlling oil inlet and oil return are arranged at the bidirectional adjusting hydraulic cylinder 310.

The operating principle of the coating roller gap adjusting device 31 is as follows: when the coating roller 32 needs to be moved (forward or backward), a flow direction of the oil pipe is changed by the two-position three-way solenoid valve of the hydraulic system, so the hydraulic cylinder rod 311 moves forward or backward to drive the coating roller seat 321 (bearing seat) to move (together with the gearbox as a whole). When the position of the coating roller 32 needs to be finely adjusted, the gap adjusting handle 314 is rotated, and the transmission worm 315 drives the transmission worm gear 316 to rotate, the adjusting nut 317 is driven to rotate by connecting to the transmission worm gear 316, so that the hydraulic cylinder rod 311 is driven to slightly move forward or backward, thus changing (finely adjusting) front and back positions of the coating roller 32 and achieving the purpose of precisely adjusting the gap between the coating rollers 32.

In other embodiments, the first metering rollers 35 and the bath rollers 36 may also be respectively provided with gap adjusting devices, as shown in figure, bath roller gap adjusting devices 38 and first metering roller gap adjusting devices 39. Each first metering roller gap adjusting device 39 is configured to adjust a displacement of the first metering roller 35 and then to adjust a gap between the metering roller and the coating roller 32. Each bath roller gap adjusting device 38 is configured to adjust a displacement of the bath roller 36, the specific arrangement mode of which is the same as that of the coating roller 32.

In some embodiments, the rollers in the coating unit are each in a form of rigid-flexible combination, and any two adjacent rollers are a rigid roller and a flexible roller, respectively. A surface of the rigid roller is encapsulated, with a surface roughness of less than 0.05, a run-out accuracy of Grade 5, and a dynamic balance of G2.5/400 rpm. The flexible roller is obtained by wrapping a layer of urethane adhesive outside the rigid roller, with a hardness of 70-80 HA. Specifically, the bath roller is a flexible roller, the first metering roller 35 is a rigid roller, the second metering roller is a flexible roller, the transfer roller is a rigid roller, and the coating roller is a flexible roller.

In some embodiments, the transfer roller 33 is a ceramic roller with an alumina surface layer, with a surface roughness of less than 0.05, a run-out accuracy of Grade 5, and a dynamic balance of grade G2.5/400 rpm. The surface wear of the roller can be reduced to the greatest extent, and the purposes of durability, long-term stability and high precision are achieved.

In some embodiments, the bath roller has good lubrication due to organosilicon filled in the bath, so it is unnecessary to use ceramic roller. Hard chromium plating is required on the roller surface of the bath roller. After fine grinding, the hard chromium has a residual thickness of 0.1 mm, a surface roughness of less than 0.05, a run-out accuracy of Grade 5, and a dynamic balance of G2.5/400 rpm.

In some embodiments, the speeds of the rollers in the coating units are controlled in a vector closed-loop control mode, and in cooperation with an encoder with resolution greater than 2000 P/R to achieve frequency conversion speed regulation with high-precision and high-rigidity. The rollers can run in a frequency of 0.01 Hz without jamming, thus ensuring the precise control and high stability of the coating amount.

In some embodiments, the suspension oven 4 is used to achieve the suspension of the substrate by blowing air through upper and lower air nozzles 41. Each air nozzle 41 includes an air inlet and an air outlet 411, and a buffer plate 415 is arranged between the air inlet and the air outlet 415.

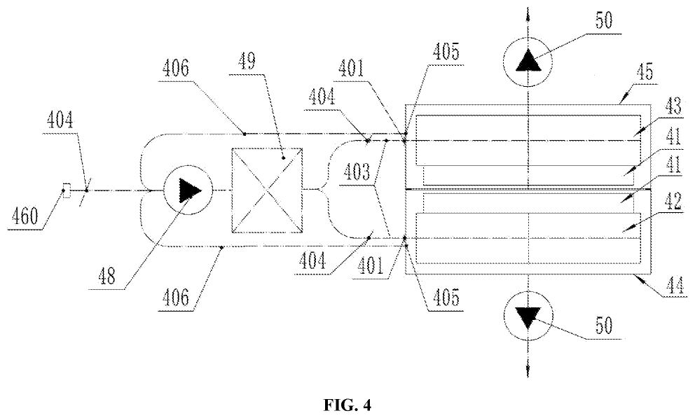

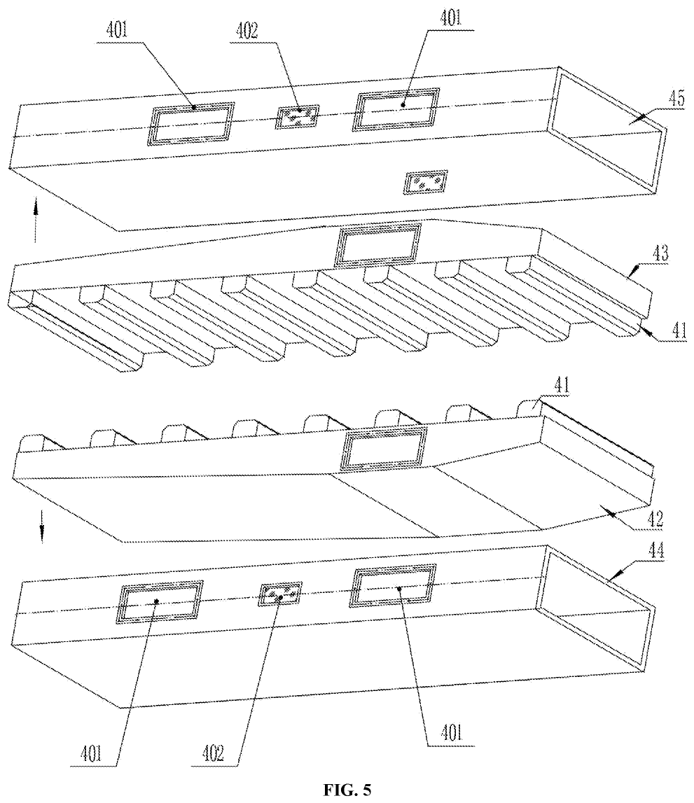

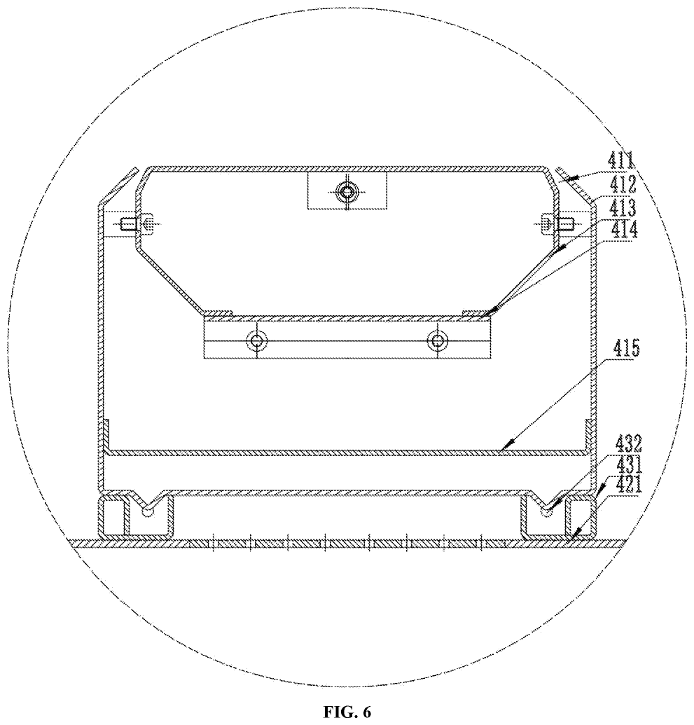

Specifically, as shown in FIG. 4, FIG. 5 and FIG. 6, the suspension oven 4 is consisted of two parts: an upper oven 45 and a lower oven 44. Opposite surfaces of the upper oven 45 and the lower oven 44 are open, and an upper air inlet chamber 43 and a lower air inlet chamber 42 are arranged in the upper oven 45 and the lower oven 44, respectively. The opposite sides of both the upper air inlet chamber 43 and the lower air inlet chamber 42 are connected to air nozzles, and an exhaust chamber is the space except for the air inlet chamber in the oven box body. To facilitate the passing (of the substrate), the upper oven 45 can be driven by a hydraulic cylinder to approach and move away from the lower oven 44 (the lower oven 44 does not move, and the upper oven 45 is connected to the hydraulic rod to lift and lower). Silicone rubber pads are laid on contact surfaces on both sides of the upper oven 45 and the lower oven 44 to prevent airflow between the upper oven 45 and the lower oven 44 from leaking from side edges, and silicone rubber plates are laid on upper and lower joints of the upper oven 45 and the lower oven 44. An air inlet duct connecting port 401 and an air return duct connecting port 405 are formed on each oven box body. The air inlet duct connecting port 401 is connected to an air inlet duct 403, and the air return duct connecting port 405 is connected to an air return duct 406. Hot air, after being produced, enters the air chambers in the upper oven 45 and the lower oven 44 through the air inlet duct 403 and then is ejected through the air nozzles 41.

Each air nozzle 41 includes an inner cover 413, an outer cover 412, and a buffer plate 415. An air inlet is formed in the outer cover 412, and the air inlet is in communication with the air inlet chamber. The outer cover 412 is of an open structure, and a gap between the outer cover 412 and the inner cover 413 forms the air outlet 411. The buffer plate 415 is arranged between the air inlet and the air outlet 411, and regular holes are formed on the buffer plate 415 for buffering and resisting wind dispersion, so the air from the air nozzle 41 is more uniform. A structure connecting plate with an air inlet is arranged below the buffer plate 415. The air nozzle 41 is mounted on a base plate 421 of each of the upper air inlet chamber 43 and the lower air inlet chamber 42. Positioning grooves 431, which are convenient for mounting the air nozzles 41, are arranged on the upper air inlet chamber 43 and the lower air inlet chamber 42, and the air nozzles 41 are accurately mounted at fixed positions through end clamping plates 432 in the positioning grooves 431.

The upper and lower air nozzles 41 are centrally arranged in a staggered manner, and the air inlet duct 403 connected to the oven is in communication with a group of hot air producing heat sources produced by direct-fired injection of natural gas. The heat source, after passing through a circulating fan 48, forms air kinetic energy to enter the air nozzles 41. In order to adjust a suspension state of the substrate, an air brake 404 for adjusting air volume and air pressure is arranged between an outlet of the circulating fan 48 and an inlet of an air duct of the oven. The air brake 404 is rotated by a driving motor mounted on a central shaft of the air brake 404 to open and close, and the air volume and air pressure of the air duct of the oven can be changed by adjusting an angle of a plate of the air brake 404, such that the suspension state of the substrate can be controlled by adjusting the air volume of the upper and lower air ducts in a cooperative manner, thus ensuring that the substrate can wander in the space of the upper and lower air nozzles. For the convenience of adjustment, the driving motor and an angle sensor are mounted on the central shaft of the air brake 404, and the angle sensor and the driving motor form a closed-loop control. The motor can be commanded to drive by inputting an angle value of the air brake 404 through a touch screen interface, and the driving motor stops after the air brake 404 is rotated to specified angle. Therefore, stable airflow is produced in the upper and lower air ducts to guarantee the stable suspension of the substrate in the oven.

In order to observe the suspension state of the substrate in the oven conveniently, two observation windows 402 and a barometer for detecting the air pressure in the oven are arranged on a side surface of the oven, which are used in the debugging of the suspension state of the substrate.

The oven heating is achieved by burning and directly injecting the heating source by a natural gas burner. The heat source is connected to the air inlet duct connecting port 401 of the oven through the circulating fan 48, a pipeline, the air brake 404 and the air inlet duct 403. The air enters the air nozzles 41 through the upper air chamber and the lower air chamber. When the ejected air colliding with the surface of the substrate, it flows back into the oven to achieve the purpose of hot air backflow. The hot air flowed back flows into the air return duct through the air return duct connecting port. The other end of the air return duct is in communication with an air inlet of the heat source through the circulating fan, so as to achieve the purpose of hot air recovery and improve the utilization of heat energy. In order to eliminate moisture and impurities, a fresh air inlet is also provided to communicate with the heat source through the circulating fan, and the air intake volume of fresh air is controlled by a rotation angle of the air brake 404. A filter 460 is mounted in front of the inlet to control the intake volume of the fresh air, and the exhausted waste gas is forcibly discharged to the outside by a centrifugal fan 50.

The coating on the substrate can be subjected to rapid crosslinking and curing after being heated by the oven. In order to adapt to processes of different material, the oven can be automatically operated to achieve the setting temperature, and fuel of the burner 49 is supplied according to the temperature by a proportional valve, and the temperature is controlled by a PID (Proportional-Integral-Derivative) control mode, so as to adapt to full-speed heating in a cold state. Fine adjustment can be carried out when approaching the setting temperature, thus making the temperature more accurate.

In some embodiments, an oven section tension detection device 5 is arranged at a rear side of the oven to detect the tension of the substrate.

In some embodiments, the post-treatment device includes an air-cooling device 6, a cooling and ironing device 8 and a steam rewetting device 10 which are arranged in sequence. The air-cooling device 6 is configured to cool the thermally cured material, the cooling and ironing device 8 is configured to cool and iron the cooled material, and the steam rewetting device 10 is configured for steam rewetting of the ironed and cooled material by adopting an electrostatic field.

The dried material enters an edge tracking swing roller 7 after passing through the air-cooling device 6, and then enters the cooling and ironing device 8. The cooling and ironing device 8 is consisted of a group of cold cylinders (two), in which cooling water is introduced, and the cooling water forms a closed-loop cycle through pipelines, an air cooler and the cold cylinders. The air in a cooling tower takes away the heat of water to achieve the purpose of cooling the material. If the cold cylinder is competent for all cooling functions, the fan in the air-cooling device 6 may not be turned on or the ventilation rate of the fan can be lowered.

The cooled and ironed material enters the steam rewetting device 10. In order to prevent excessive steam from producing and overflowing during the rewetting, an overheating two-stage steam rewetting device 10 with an electrostatic field, a secondary cooling and ironing device 11 and a tension detection assembly before secondary rewetting 12 are used in the this process, with the purpose of gathering the steam on the surface of the material to reduce steam loss caused by the impact on the surface of the material; and moreover, uneven surface of the product caused by excessive steam is avoided, and the surface of the product is smoother. The steam rewetting amount is controlled by a proportional valve, through an instruction mode using speed and rewetting amount as composite superposition amount, the rewetting of the material is more uniform, and the requirements of moisture content and speed of a paper substrate are satisfied at the same time. Because the paper after steam rewetting has a high temperature, which is not conducive to the second steam rewetting, the rewetted substrate will be cooled and ironed again, and after cooling and ironing, the material is still cooled to a room temperature or close to a room temperature before entering the next steam rewetting (secondary steam rewetting). The basic requirements of the secondary steam rewetting device 13 are the same as those of the steam rewetting device 10.

During the process of rewetting, in order to make the material absorb steam moisture more easily, low tension is conducive to the adsorption capacity of the material. Therefore, in front of each steam rewetting device 10, a tension detection assembly before rewetting 9 capable of controlling the tension is provided, and the tension detection assembly before rewetting 9 includes independent power transfer and independent tension detection functions.

The material, after being subjected to the secondary steam rewetting by the secondary steam rewetting device 13, needs to be cooled, and the cooling design is to cool the material to a ambient temperature state. The adopted cooling mode is the same as that adopted after the primary rewetting. The product enters the winding device 15 and is wound on the winding shaft. The edge tracking swing roller 7 mounted between the outlet of the oven and a vertical section is used for the deviation correction of winding uniformity of the winding device 15. Winding tension swing rollers 151 are arranged in front of the winding shaft for tension adjustment, such that the winding shaft can adapt to the winding tension of different materials. When the winding shaft is fully wound, the product can be automatically cut off to complete the whole process.

In some embodiments, an ironing device before winding 14 is arranged in front of the winding device 15.

Specific examples are used herein for illustration of the principles and implementation methods of the present disclosure. The description of the embodiments is merely used to help illustrate the method and its core principles of the present disclosure. In addition, those skilled in the art can make various modifications in terms of specific embodiments and scope of application in accordance with the teachings of the present disclosure. In conclusion, the content of this specification shall not be construed as a limitation to the present disclosure.

What is claimed is:

1. A double-sided disposable coating device, comprising:
an unwinding device, a substrate roll is arranged on the unwinding device, and the unwinding device is configured to release a substrate;
a double-sided coating device, the double-sided coating device is configured to perform double-sided coating on the substrate released from the unwinding device;
a suspension oven, the suspension oven is configured to perform double-sided drying on a coated substrate;
a post-treatment device, the post-treatment device is configured to perform post-treatment on a dried material; and
a winding device, the winding device is configured to wind a finished product after post-treatment.

2. The double-sided disposable coating device according to claim 1, wherein a coating used in the double-sided coating device is a solvent-free thermosetting organosilicon release agent with a viscosity of 200-500 CPS.

3. The double-sided disposable coating device according to claim 1, wherein the double-sided coating device comprises a coating channel and coating units, the coating channel is configured for the substrate to pass through, the coating units are arranged on both sides of the coating channel, and each of the coating units comprises a bath roller, metering rollers, a transfer roller, and a coating roller; a bath is formed by the bath roller, the metering rollers, and port baffles at ports of the bath roller and the metering rollers; the coating roller, the transfer roller, the metering rollers and the bath are arranged from the coating channel in a direction away from the coating channel in sequence; rotational speeds of the metering rollers, the transfer roller and the coating roller are adjustable, and a coating amount of a coating is adjusted by controlling a speed difference among the metering rollers, the transfer roller, and the coating roller.

4. The double-sided disposable coating device according to claim 3, wherein rollers in the coating units are each in a form of rigid-flexible combination, and any two adjacent rollers of the rollers are a rigid roller and a flexible roller, respectively; a surface of the rigid roller is encapsulated, with a surface roughness of less than 0.05, a run-out accuracy of Grade 5, and a dynamic balance of G2.5/400 rpm; and the flexible roller is obtained by wrapping a layer of urethane adhesive outside the rigid roller, with a hardness of 70-80 HA.

5. The double-sided disposable coating device according to claim 3, wherein the transfer roller is a ceramic roller with an alumina surface layer, with a surface roughness of less than 0.05, a run-out accuracy of Grade 5, and a dynamic balance of G2.5/400 rpm.

6. The double-sided disposable coating device according to claim 3, wherein speeds of the rollers in the coating units are controlled in a vector closed-loop control mode, and in cooperation with an encoder with resolution greater than 2000 P/R to achieve frequency conversion speed regulation with high-precision and high-rigidity.

7. The double-sided disposable coating device according to claim 1, further comprising a corona device, the corona device is configured to treat a surface of the substrate and then the substrate is conveyed to the double-sided coating device for coating.

8. The double-sided disposable coating device according to claim 1, wherein the suspension oven is configured to achieve suspension of the substrate by blowing air through air nozzles, each of the air nozzles comprises an air inlet and an air outlet, and a buffer plate is arranged between the air inlet and the air outlet, and small holes are uniformly formed in the buffer plate.

9. The double-sided disposable coating device according to claim 1, wherein the post-treatment device comprises an air-cooling device, a cooling and ironing device and a steam rewetting device which are arranged in sequence, the air-cooling device is configured to cool a thermally cured material, the cooling and ironing device is configured to cool and iron a cooled material, and the steam rewetting device is configured to perform steam rewetting on an ironed and cooled material by means of an electrostatic field.

10. The double-sided disposable coating device according to claim 9, wherein a steam rewetting amount of the steam rewetting device is controlled by a proportional valve, and the steam rewetting amount is controlled through a combination of a production speed of the material and a specified rewetting amount.
